(19) United States
(12) Patent Application Publication
(10) Pub. No.: US 2002/0092802 A1
(43) Pub. Date: Jul. 18, 2002

(54) Power factor correction for centrifuges

(76) Inventors: Robert R. Evana III, Framingham, MA (US); Dara McMahon, Natick, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/908,486

(22) Filed: Jul. 17, 2001

Related U.S. Application Data
(60) Provisional application No. 60/218,702, filed on Jul. 17, 2000.

(51) Int. Cl. B01D 17/038

(52) U.S. Cl. 210/143; 210/512.1; 494/1; 494/10

(57) ABSTRACT

A centrifuge system including a rotor constructed and arranged to hold at least one sample to be centrifuged, a motor, operatively coupled to the rotor, to rotate the rotor, a power supply, for connection to a power source, to supply power to the motor, and an active power factor correction circuit incorporated into the power supply to increase the power factor of the power supply.

### CROSS REFERENCE TO RELATED APPLICATIONS

This application claims the benefit of U.S. Provisional Application Serial No. 60/218,702 entitled POWER FACTOR CORRECTION FOR CENTRIFUGES, filed Jul. 17, 2000; which application is hereby incorporated herein by reference.

### BACKGROUND OF THE INVENTION

1. Field of the Invention

The present invention relates generally to centrifuge systems. More particularly, the present invention relates to power factor correction in the power supplies of a centrifuge system.

2. Discussion of the Related Art

The basic operation of a centrifuge can be described as converting electrical energy into rotational energy. This rotational energy is typically quantified as relative centrifugal force. Various types of motors are used to provide rotational energy, and the allowable current demand and the efficiency of converting the raw input power into rotational motion limit the maximum speed that can be achieved. For certain market segments and classes of machines, it is desirable to use a standard 120 VAC/15 Amp utility connection, as this is a standard configuration. Thus, the absolute maximum power available is 1800 Watts. Safety standards and circuit overload devices further limit the maximum current that can be drawn from the connection. Typically this is 12 Amps for a 15 Amp connection. Thus the actual available power is 1440 Watts. This upper limit will be reduced further by the need to perform temperature control (for example, refrigeration). A successful design will balance the power used by the motor (and the maximum velocity) and the power used by the refrigeration system. Typically, a refrigeration system is designed to be able to provide the required cooling at the maximum rotational velocity of a particular centrifuge. The power required to provide this cooling must therefore be subtracted from the maximum available power. Typical refrigeration systems include a motor to perform the compression of the cooling gas required for effective heat removal. In some cases, the power necessary for the refrigeration system may consume up to one-half of the power available from the utility connection.

The fact that the terminal characteristics of the centrifuge are fundamentally a motor and motor/drive system has further impact on the achievable performance. The system is a reactive system. These types of components are fundamentally inductive and or capacitive in nature, meaning that the current and voltage are phase displaced. Real work can only be done by the components of the current and voltage that are in phase, so the 120 VAC, 12 Amp limit will do considerably less work. Typically, these systems will yield 70 to 80 % utilization. Thus, the system will draw 1440 watts of apparent power, while doing 70 to 80% of this value in real power.

There may be other electrical components in the centrifuge system that further reduce the available power.

The ratio of the real power to the apparent power is called the power factor for the system.

Power Factor Correction (PFC), is the technique of introducing additional components into the system to increase the power factor and either reduce the current demand for a given power or increase the available power at the same (maximum) current demand.

Historically, passive PFC has been provided by using additional capacitors for systems that are fundamentally inductive, or inductors for the fundamentally capacitive systems. Implementation considerations constrain the application of these components in many cases, and further, these solutions will be less effective for systems that have inherent non-linear characteristics. Motor drives that use pulse width modulation (PWM) techniques to control the speed have inherent non-linear characteristics due to the averaging and switching nature of PWM.

### SUMMARY OF THE INVENTION

The present invention provides a centrifuge system, including a rotor constructed and arranged to hold at least one sample to be centrifuged, a motor, operatively coupled to the rotor, to rotate the rotor, a power supply, for connection to a power source, to supply power to the motor, and an active power factor correction circuit incorporated into the power supply to increase a power factor of the power supply.

According to an embodiment of the invention, the power factor is at least 0.90.

According to an embodiment of the invention, the power supply is a voltage boost type power supply.

According to an embodiment of the invention, the power supply is a zero-voltage switching type power supply.

According to an embodiment of the invention, the power supply is a zero-current switching type power supply.

According to an embodiment of the invention, the power supply is a resonant switching type power supply.

According to an embodiment of the invention, the active power factor correction circuit reduces electrical noise produced by the power supply that may be conducted to the power source.

According to an embodiment of the invention, the electrical noise includes harmonic current.

According to an embodiment of the invention, the centrifuge system further includes a refrigeration system that maintains a desired temperature of the at least one sample.

According to an embodiment of the invention, the refrigeration system further includes a refrigeration system power supply for connection to a power source and an active power factor correction circuit incorporated into the refrigeration system power supply to increase a power factor of the refrigeration system power supply.

According to an embodiment of the invention, the active power factor correction circuit increases the power factor of the refrigeration system power supply to at least 0.90.

According to an embodiment of the invention, the active power factor correction circuit reduces electromagnetic interference produced by the refrigeration system power supply.

According to an embodiment of the invention, the active power factor correction circuit is an integrated circuit.

According to an embodiment of the invention, the active power factor correction circuit is a monolithic integrated circuit.

### BRIEF DESCRIPTION OF THE DRAWINGS

In the drawings, which are incorporated herein by reference and in which like elements have been given like reference characters,

FIG. 1 is a schematic block diagram of a centrifuge system according to the invention;

FIG. 2 is a schematic block diagram of a power supply incorporating an active power factor correction circuit that may be used in the centrifuge system of FIG. 1;

FIG. 3 is a schematic block diagram of a refrigeration system power supply that may be used in the centrifuge system of FIG. 1;

FIGS. 4, 5, and 6 are schematic diagrams illustrating the incorporation of an active power factor correction circuit into the centrifuge system of FIG. 1; and

FIG. 7 is an interconnection schematic for a centrifuge system incorporating active power factor correction.

### DETAILED DESCRIPTION

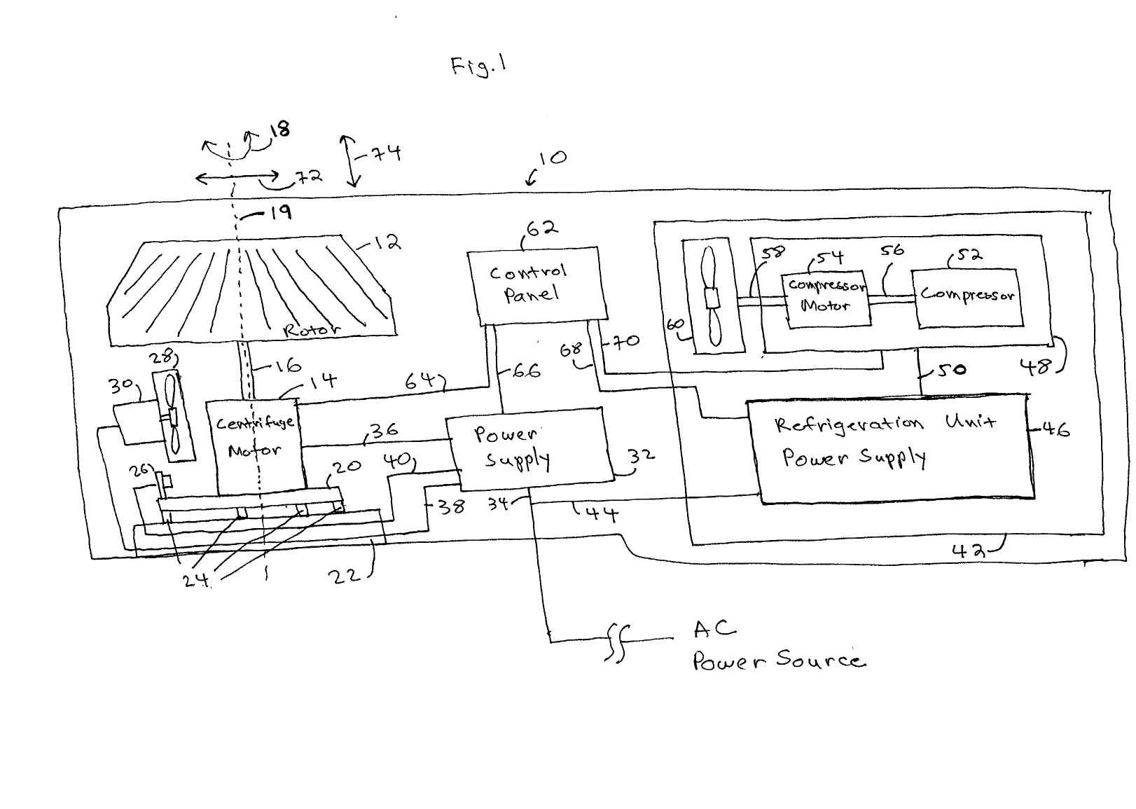

Reference is now made to FIG. 1, which figure illustrates a centrifuge system according to the present invention. Centrifuge system 10 includes a rotor 12 that is designed to hold one or more samples to be centrifuged. The rotor 12 is coupled to a centrifuge motor 14 via a shaft 16. As illustrated in FIG. 1, rotor 12, motor 14, and shaft 16 are directly connected together. One skilled in the art will appreciate that alternatively, centrifuge motor 14 may be connected to rotor 12 through some other means, such as through a gear system, a chain drive system, or a belt drive system. Rotor 12 spins about an axis of rotation 19.

Centrifuge motor 14 is mounted to a mounting system that includes base plate 20, base 22, and isolation or shock mounts 24. Shock mounts 24 may be, for example, rubber bushings. An imbalance detection system 26 is mounted to base plate 20. A cooling fan 28 and fan motor 30 are provided to cool centrifuge motor 14 during operation of centrifuge system 10.

A power supply 32 receives power from an AC power source over connection 34 and supplies appropriate power to centrifuge motor 14 via connections 36. Power supply 32 also supplies appropriate power and control signals to fan motor 30 over connection 38. Power supply 32 sends power to and receives control signals from imbalance detection system 26 over connection 40.

Centrifuge system 10 may optionally be provided with a refrigeration unit 42. Refrigeration unit 42 is used to maintain the rotor and the samples contained therein that are being centrifuged at a desired temperature. Refrigeration unit 42 receives power from the AC power source via connection 44 which supplies power to the refrigeration unit power supply 46. The refrigeration unit power supply 46 provides appropriate power and control signals to compressor unit 48 via connection 50. Compressor unit 48 includes a compressor 52 operatively coupled to compressor motor 54 via shaft 56. Compressor motor 54 has an additional shaft 58 which operates cooling fan 60.

A control panel 62 is coupled to centrifuge motor 14, power supply 32, refrigeration unit power supply 46, and compressor unit 48 via respective connections 64, 66, 68, and 70. Control panel 62 may include a display and allows an operator to control operation of centrifuge system 10, such as to select speed of rotation, duration, etc.

During operation of centrifuge system 10, rotor 12, driven by centrifuge motor 14, rotates about axis of rotation 19 in directions defined by double-headed arrow 18.

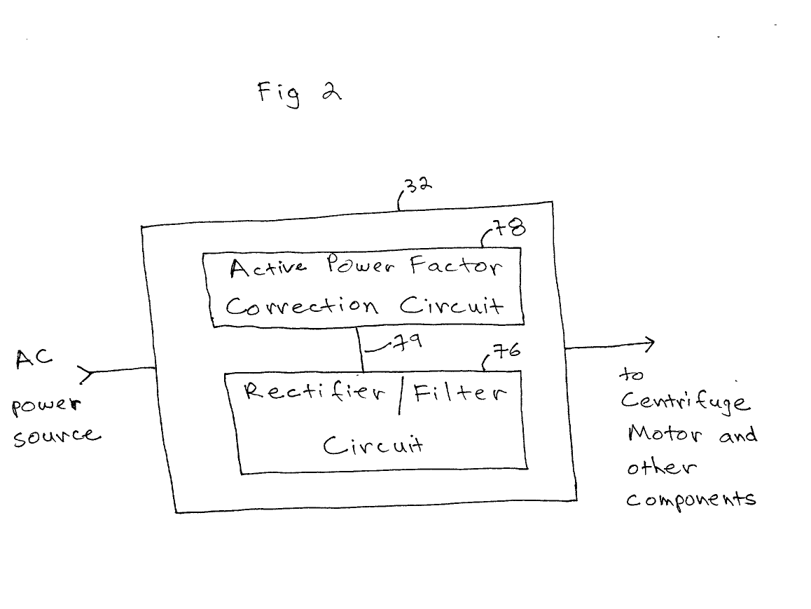

Reference is now made to FIG. 2, which figure illustrates one embodiment of centrifuge system power supply 32. Power supply 32 may be any one of a number of types of power supplies, such as a voltage boost type power supply, a zero-voltage switching type power supply, a zero-current type switching power supply, or a resonant switching type power supply. Although several types of power supplies have been listed, this list is not meant to be exhaustive. One skilled in the art will appreciate that the present invention may be used in other types of power supplies that may be used in centrifuge systems. The power supply 32 includes a rectifier and filter circuit 76 and an active power factor correction circuit 78 which is coupled to rectifier/filter circuit 76 via connection 79. Rectifier and filter circuit 76 may include a rectifier for converting the power from the AC power source to DC power and various capacitors and inductors for filtering the DC power.

Active power factor correction or active PFC, is a technique for increasing the power factor by modulating the voltage across an inductive element at a high frequency to achieve a sinusoidal input current having an average value that meets the power demands of the load, in this case, the centrifuge motor 14. Energy is stored in the inductor when the modulation is on, and delivered to centrifuge motor 14 when the modulation is off. The ratio of the on-time to the modulation cycle time is called the duty cycle. Both the input voltage waveform (the AC input from the AC power source) and the output DC voltage value control the duty cycle. The duty cycle is thus modulated in a sinusoidal fashion, and the magnitude of the modulation determines the output power. The modulation frequency and therefore the high frequency content of the output power is selected to be small when compared to the frequency of the AC power source.

The active power factor correction circuit 78 used in centrifuge power supply 32 may be any one of a number of commercially available integrated circuit or monolithic integrated circuit type devices. In one embodiment of the invention, active power factor correction circuit 78 is an LT1248 integrated circuit, manufactured by Linear Technology, Inc.

Centrifuge power supply 32, as a result of the addition of the active power factor correction circuit 78, can supply and improve the power factor of capacitive and inductive loads. In addition, since a relatively high modulation frequency is used, the nonlinear effects of motor driver circuits including, for example, pulse width modulation control, do not adversely effect the power supply. Power factors of at least 0.90 can be achieved by the invention and some embodiments can provide power factors as high as 0.95 or higher.

Use of centrifuge power supply 32 including an active power factor correction circuit results in, in some embodiments, 20 to 30 percent more power being delivered to centrifuge motor 14. This translates into a 10 to 15 percent increase in rotational speed at shaft 16 which in turn represents a 20 percent to 30 percent additional increase in the relative centrifugal force provided by rotor 12.

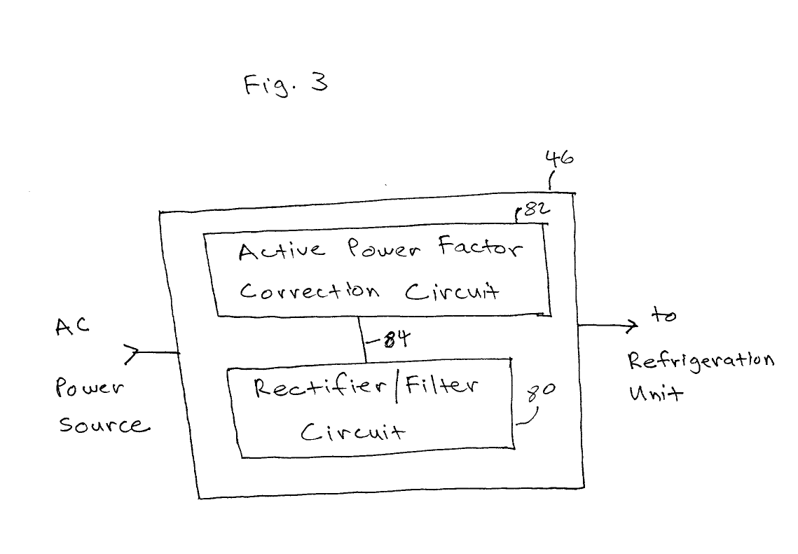

The use of a power supply with an active power factor correction circuit can also be provided in connection with the refrigeration unit. Referring to FIG. 3, refrigeration unit power supply 46 is illustrated having rectifier and filter circuit 80 and active power factor correction circuit 82 which is coupled to rectifier/filter circuit 80 via connection 84. As described above in connection with FIG. 2, the addition of active power factor correction to the refrigeration unit power supply improves the power factor of the refrigeration unit power supply and increases the power factor. The combination of active power factor correction in centrifuge power supply 32 and refrigeration unit power supply 46 can result in even higher power factors and further increases in shaft speed and relative centrifugal force provided by rotor 12.

A centrifuge system including an optional refrigeration system and active power factor correction has been discussed. One skilled in the art will appreciate that a centrifuge system could also be provided with a heating system that is used to raise the temperature of a sample to be centrifuged. Active power factor correction circuitry in accordance with the present invention can also be applied to a centrifuge system including a heating unit. Furthermore, active power factor correction circuitry in accordance with the present invention can also be used in a centrifuge system that includes both a refrigeration system and a heating system.

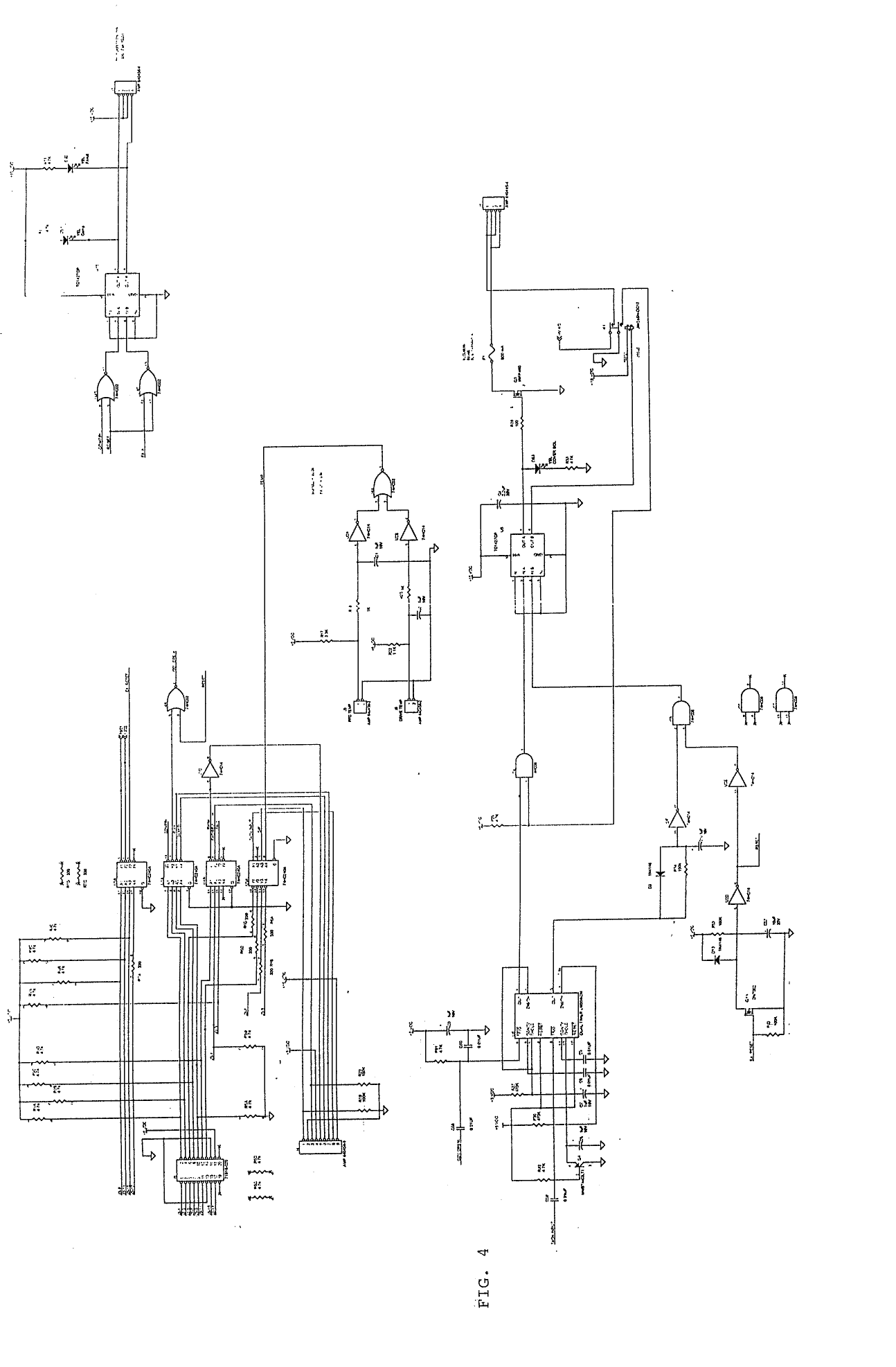

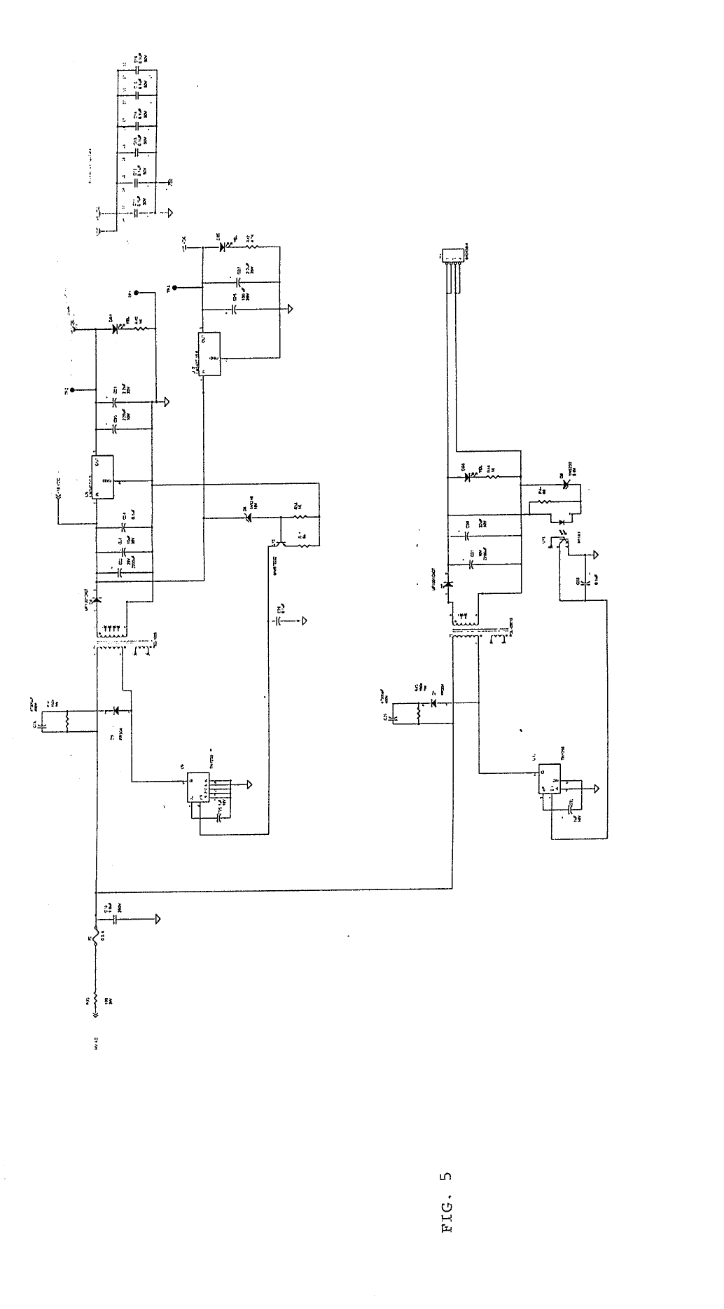

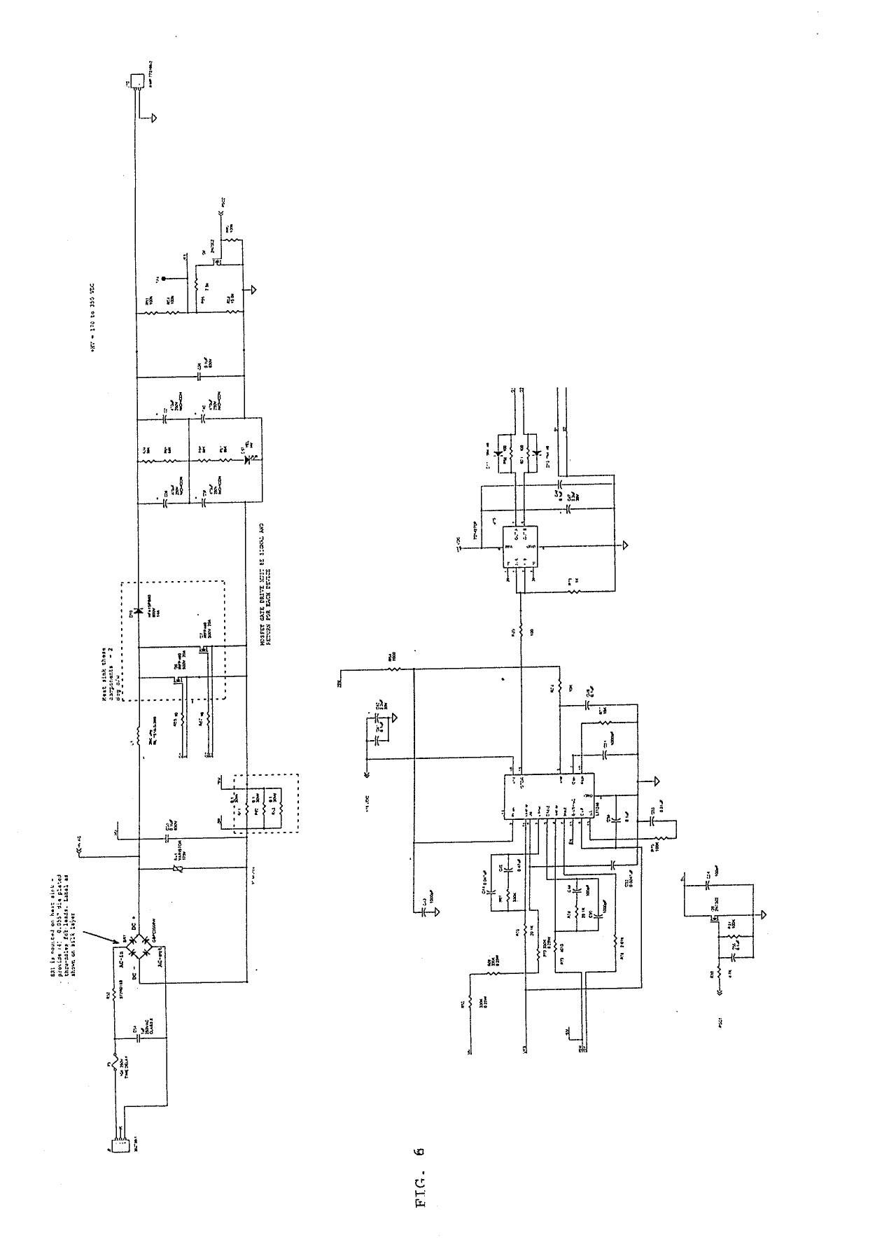

FIGS. 4, 5, and 6 are schematic diagrams illustrating the incorporation of an active power factor correction circuit into centrifuge power supply 32. In FIGS. 4, 5, and 6, the active PFC function is performed by U14, an LT1248 integrated circuit available from Linear Technology, Inc.

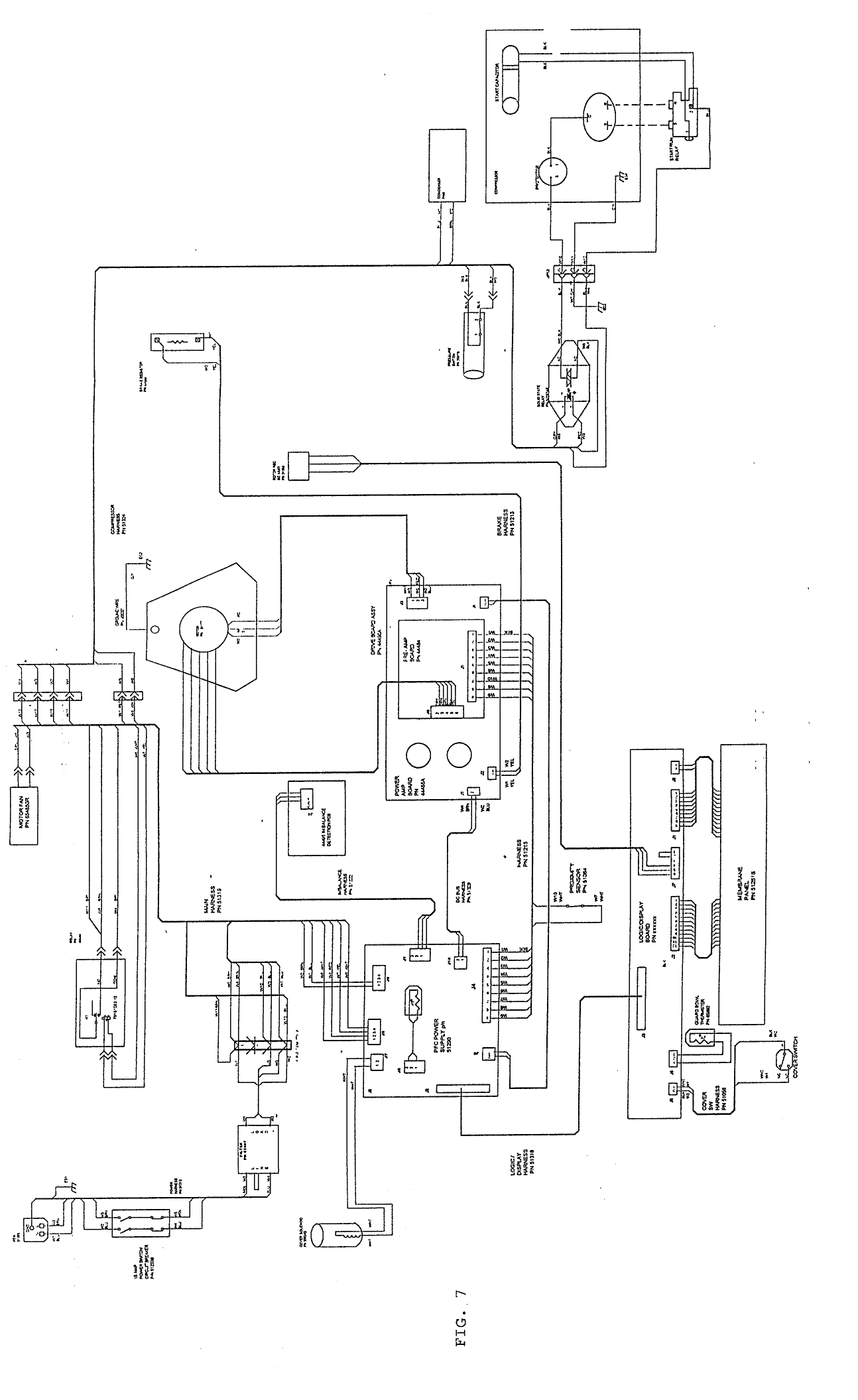

FIG. 7 is a interconnection schematic for a centrifuge system incorporating the active PFC function of the present invention.

One skilled in the art will realize that the present invention is applicable to centrifuge systems that are supplied by combinations of voltage and current limits other than the 120 volt VAC/15 Amp power source specifically discussed.

Advantages of the present invention as compared to passive PFC include higher power factors, higher rotor rotational speeds, and the ability to compensate for non-linear control techniques, such as pulse width modulation used to control the rotational speed of centrifuge motor 14.

Another advantage of the present invention includes the ability to be able to comply with ever-tightening regulatory requirements with respect to electrical noise, such as harmonic currents, that may be conducted back to the AC power source. The use of active power factor correction circuits allows for a reduction in electromagnetic interference transmitted onto the AC power lines. The use of a resonant type switching power supply, designed to switch the load when the current and/or load voltage is zero is advantageous because it reduces the stresses and the switching losses in the power supply which in turn reduces the necessary cooling, the size, and cost of the power supply. This in turn allows higher operating frequencies which in turn allows for smaller and less expensive components such as the switches, inductors, capacitors, and diodes that make up the power supply. When combined with the active power factor correction circuits of the present invention, a resonant switching type power supply provides further reductions in electrical noise, both conducted and radiated, while at the same time increasing the power factor.

Having thus described at least one illustrative embodiment of the invention, various alterations, modifications, and improvements will readily occur to those skilled in the art. Such alterations, modifications, and improvements are intended to be within the spirit and scope of the invention. Accordingly, the foregoing description is by way of example only and is not intended as limiting. The invention is limited only as defined in the following claims and the equivalents thereto.

What is claimed is:

1. A centrifuge system, comprising:
a rotor constructed and arranged to hold at least one sample to be centrifuged;
a motor, operatively coupled to the rotor, to rotate the rotor;
a power supply, for connection to a power source, to supply power to the motor; and
an active power factor correction circuit incorporated into the power supply to increase a power factor of the power supply.

2. The centrifuge system of claim 1, wherein the power factor is at least 0.90.

3. The centrifuge system of claim 1, wherein the power supply is a voltage boost type power supply.

4. The centrifuge system of claim 1, wherein the power supply is a zero-voltage switching type power supply.

5. The centrifuge system of claim 1, wherein the power supply is a zero-current switching type power supply.

6. The centrifuge system of claim 1, wherein the power supply is resonant switching type power supply.

7. The centrifuge system of claim 1, wherein the active power factor correction circuit reduces electrical noise produced by the power supply that may be conducted to the power source.

8. The centrifuge system of claim 7, wherein the electrical noise comprises harmonic current.

9. The centrifuge system of claim 1, further including a refrigeration system that maintains a desired temperature of the at least one sample.

10. The centrifuge system of claim 9, wherein the refrigeration system further includes a refrigeration system power supply for connection to a power source and an active power factor correction circuit incorporated into the refrigeration system power supply to increase a power factor of the refrigeration system power supply.

11. The centrifuge system of claim 10, wherein the active power factor correction circuit increases the power factor of the refrigeration system power supply to at least 0.90.

12. The centrifuge system of claim 10, wherein the active power factor correction circuit reduces electrical noise produced by the refrigeration power supply that may be conducted to the power source.

13. The centrifuge system of claim 12, wherein the electrical noise comprises harmonic current.

14. The centrifuge system of claim 1, wherein the active power factor correction circuit comprises an integrated circuit.

15. The centrifuge system of claim 11, wherein the active power factor correction circuit comprises a monolithic integrated circuit.

16. The centrifuge system of claim 10, wherein the active power factor correction circuit incorporated into the refrigeration system power supply comprises an integrated circuit.

17. The centrifuge system of claim 16, wherein the active power factor correction circuit incorporated into the refrigeration system power supply comprises a monolithic integrated circuit.

18. A centrifuge system, comprising:
a rotor constructed and arranged to hold to at least one sample to be centrifuged;
a motor, operatively coupled to a rotor, to rotate the rotor;
a power supply, for connection to a power source, to supply power to the motor; and
active power factor correction means, incorporated into the power supply, for increasing a power factor of the power supply.

19. The centrifuge system of claim 18, wherein the active power factor correction means increases the power factor of the power supply to at least 0.90.

20. The centrifuge system of claim 18, wherein the power supply is a voltage boost type power supply.

21. The centrifuge system of claim 18, wherein the power supply is a zero-voltage switching type power supply.

22. The centrifuge system of claim 18, wherein the power supply is a zero-current switching type power supply.

23. The centrifuge system of claim 18, wherein the power supply is resonant switching type power supply.

24. The centrifuge system of claim 18, wherein the active power factor correction circuit reduces electrical noise produced by the power supply that may be conducted to the power source.

25. The centrifuge system of claim 24, wherein the electrical noise comprises harmonic current.

26. The centrifuge system of claim 18, further including a refrigeration system that maintains a desired temperature of the at least one sample.

27. The centrifuge system of claim 26, wherein the refrigeration system further includes a refrigeration system power supply for connection to a power source and active power factor corrections means incorporated into the refrigeration system power supply for increasing a power factor of the refrigeration system power supply.

28. The centrifuge system of claim 27, wherein the active power factor correction means increases the power factor of the refrigeration power supply to at least 0.90.

29. The centrifuge system of claim 18, wherein the active power factor correction means comprises an integrated circuit.

30. The centrifuge system of claim 29, wherein the active power factor correction means comprises a monolithic integrated circuit.

31. The centrifuge system of claim 27, wherein the active power factor correction means incorporated into the refrigeration system power supply comprises an integrated circuit.

32. The centrifuge system of claim 31, wherein the active power factor correction means incorporated into the refrigeration power supply comprises a monolithic integrated circuit.
